(19) United States
(12) Patent Application Publication
(10) Pub. No.: US 2018/0165656 A1
(43) Pub. Date: Jun. 14, 2018

(54) DYNAMIC INVITEE-DRIVEN CUSTOMIZATION AND SUPPLEMENTATION OF MEETING SESSIONS

(71) Applicant: MarketechCorp., Houston, TX (US)

(72) Inventor: Avigdor TESSLER, Houston, TX (US)

(73) Assignee: MarketechCorp., Houston, TX (US)

(21) Appl. No.: 15/838,215

(22) Filed: Dec. 11, 2017

Related U.S. Application Data
(60) Provisional application No. 62/432,483, filed on Dec. 9, 2016.
(60) Provisional application No. 62/443,574, filed on Jan. 6, 2017.

(51) Int. Cl. G06Q 10/10; G06F 3/0484

(52) U.S. Cl. CPC G06Q 10/1095; G06F 3/04842

(57) ABSTRACT

Dynamic meeting customization begins with the creation of a meeting invitation object based on one or more host customization parameters received from a host. The meeting invitation object is transmitted to one or more invitees. An invitee user interface is presented in response to a given invitee interacting with the meeting invitation object, and one or more invitee customization parameters and supplemental meeting options are received from the invitee user interface. A scheduled meeting object is created based on the meeting invitation object and the invitee customization parameters, such that the scheduled meeting object corresponds to a scheduled meeting time. Prior to the scheduled meeting time, a confirmation request is transmitted to the given invitee. In response the given invitee confirming the confirmation request, the supplemental meeting options are combined with the scheduled meeting object to generate a customized meeting session between the host and the given invitee.

### CROSS-REFERENCE TO RELATED APPLICATIONS

This application claims priority to U.S. Provisional Patent Application No. 62/432,483 filed on Dec. 9, 2016 for a VIDEO MEAL MEETING SYSTEM AND METHOD, and to U.S. Provisional Patent Application No. 62/443,574 filed on Jan. 6, 2017 for a VIDEO MEAL MEETING SYSTEM AND METHOD, the contents of which both are hereby expressly incorporated by reference in their entirety.

### TECHNICAL FIELD

The present technology pertains to online meetings, and more specifically to scheduling and generating customized meeting sessions between a host and one or more invitees.

### BACKGROUND

Video conferences and online meetings have become quintessential tools in both business and everyday life. A variety of technological advances have been made in the area of online and online-compatible meeting platforms and meeting tools, and online meetings and communications continue to gain popularity. While these advances have aided in the modernization of the traditional face-to-face or in person meeting, their scheduling and provisioning mechanisms are most often static or manually operated. For example, while various optimizations and improvements have been made to permit increased video quality and stability given the same amount of bandwidth, video meetings are still traditionally scheduled and configured entirely by the host of the meeting, such that the host selects the meeting time, the meeting location, and even the meeting platform. Moreover, while video meetings have changed the way meetings are being conducted, a new challenge has been created by video meetings, specifically, getting invitees to attend the video meetings they have provided confirmation they will attend. Video meetings, unlike traditional face-to-face or in person meetings, have no pressure or requirements for the invitee to attend. For example, when a host is physically present at an invitee's place of business, the invitee has the pressure of attending the meeting they had previously agreed upon. Conversely, when there is no physical presence and the meeting is strictly video based, the invitee has minimal pressure to attend and can simply skip the video meeting without the thought of it inconveniencing the host.

Accordingly, it would be desirable to provide online meetings with dynamic customization capabilities such that the resulting meeting session can be adjusted and supplemented based on invitee inputs, along with adding pressure to the invitee to actually attend the meeting they have agreed to attend.

### BRIEF DESCRIPTION OF THE DRAWINGS

In order to describe the manner in which the above-recited and other advantages and features of the disclosure can be obtained, a more particular description of the principles briefly described above will be rendered by reference to the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system architecture of the present disclosure;

FIG. 2 illustrates an example host user interface of the present disclosure;

FIG. 3A illustrates an example meeting invitation and invitee interface of the present disclosure;

FIG. 3B illustrates an example scheduling user interface of the present disclosure;

FIG. 4 illustrates an example invitation manager user interface of the present disclosure;

FIG. 5 illustrates an example campaign user interface of the present disclosure;

FIG. 6A illustrates an example analytics user interface of the present disclosure;

FIG. 6B illustrates an example analytics user interface of the present disclosure;

FIG. 6C illustrates an example lead conversion interface of the present disclosure;

FIG. 7 illustrates an example flowchart of a method of the present disclosure;

FIG. 8A depicts a conventional system bus computing system architecture; and

FIG. 8B depicts an example computer system having a chipset architecture.

### DETAILED DESCRIPTION

Various elements of the disclosure are discussed in detail below. While specific implementations are discussed, it should be understood that this is done for illustration purposes only. A person skilled in the relevant art will recognize that other components and configurations may be used without parting from the spirit and scope of the disclosure. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles herein.

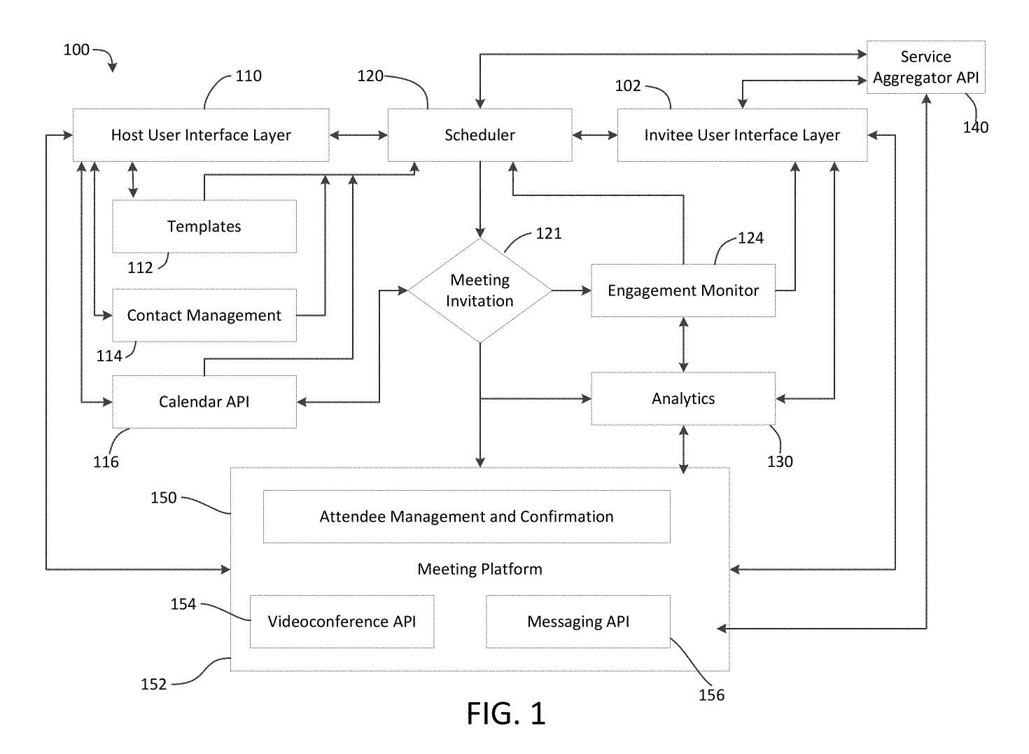

The disclosure turns now to FIG. 1, which depicts an example architecture 100 for an online video meeting system of the present disclosure. The architecture 100 depicts various sub-systems and sub-components of the disclosed online video meeting system, along with their various interconnections and communicative links. Although a particular configuration of sub-systems and sub-components is illustrated, it is appreciated that various individual sub-systems and sub-components can be combined into a composite entity without departing from the scope of the present disclosure.

Architecture 100 contains a host user interface layer 110 and an invitee user interface layer 102, which collectively form a front (e.g. user facing) end of the disclosed online video meeting system. Although depicted as distinct components, in some embodiments a single user interface layer might be provided, wherein host users and invitee users can be distinguished, for example, via different login credentials or different permissions granted to an associated user account. This front end can be provided as an online website via one or more servers or virtual servers employing various web hosting techniques as are known in the art.

Host user interface layer 110 allows a user to configure a meeting or a meeting invitation, both of which can subsequently be transmitted to one or more invitees. In some embodiments, a user might first be required to register as a host before being granted access to host user interface layer 110 or before otherwise being granted access to the ability to create meetings and invite users to attend. The invitee user interface layer 102 may itself be used to transmit a meeting invitation, or may be linked to via an invitation conveyed by an external or third-party system or platform. However, while the transmission of a meeting invitation is an ultimate result observable by both a host and one or more invitees, a number of intervening steps and components are involved.

A scheduler system 120 is depicted as communicatively coupled between host user interface layer 110 and invitee user interface layer 102. In this manner, scheduler system 120 can receive a scheduling request (or a scheduling parameter or rule modification) from host user interface layer 110, and in response can initiate the scheduling process. In some embodiments, when a host user is already registered or is otherwise recognized by scheduler 120, various scheduling parameters, rule modifications, or other configuration changes that are specific to the host user account or are specific to a policy (e.g. a company-wide policy) for the host user account can be recalled or otherwise automatically loaded by scheduler 120.

For example, as depicted in architecture 100, each host user instance can be associated with a template repository 112, a contact management system 114, and a calendar API 116, which collectively provide one or more inputs to the scheduler 120 for creating meeting and meeting invitation objects, such as meeting invitation object 121, which will be discussed in greater depth below. First, however, these three components can be registered or otherwise communicatively coupled to the scheduler 120.

In some embodiments, a separate database might be provided for each of the three components. That is, the meeting system architecture 100 might include a centralized template database (not shown) for storing the template repository 112 of each host user, a centralized contact database (not shown) for storing the contact management system 114 of each host user, and a centralized calendar database (not shown) for storing calendar information retrieved from a calendar API 116 specified by each host user. In some embodiments, these three individual databases might instead be represented as logical partitions on a single database. Independent of the underlying database architecture, it is contemplated that data might be siloed for individual host users (that is, is host A and host B both have the same contact ‘Bob B.’ saved separately) or data might be indexed to remove redundant entries (that is, host A and host B both access the same, single saved copy of the contact ‘Bob B.’), wherein the data storage scheme can depend on factors such as available storage space, desired redundancy, and privacy and data integrity regulations or policies.

Template repository 112 can include various templates containing text for extending a meeting invitation. For example, template repository 112 might include templates for common meeting types, such as ‘Introduction to Account Manager’, ‘Survey Initiation’, ‘Webinar Invitation’, ‘Partnership Discussion’, etc. These templates might include a default setting that it is automatically configured in the template repository 112 for each host user upon registering with the disclosed meeting system, an administrator-specified setting that is automatically configured in the template repository 112 for each host user according to a policy specified by an administrator of the host user account (e.g. a company-wide template selection could be applied to all host users that are employees of the company), or a customized setting that is specified by the host user via the host user interface layer 110. In general, it is contemplated that the templates stored in template repository 112 can be field-denominated such that any information specific to an invitee can be inserted via scheduler 120. In some embodiments, the templates can be configured such that scheduler 120 can insert invitee-specific information, if available, in place of a default or placeholder phrase. If the needed invitee-specific information is not provided or is not otherwise available, then the default or placeholder phrase can simply be left in place without issue. For example, a template for a meeting invitation might include the sentence “I would enjoy the opportunity to hear more about yourself and <your company>”. If available, the invitee's company name can replace ‘your company’. If not available, ‘your company’ can remain in place, such that the sentence reads naturally regardless of whether or not customization is applied.

Such invitee-specific information can be stored in contact management system 114, which, as mentioned previously, might store individual entries for every contact of each host user (thereby ignoring duplicates), or might store only unique entries of the contacts of each host user (thereby removing duplicates). Stored contact management information can include name, age, height, build, demographic information, job title, employer, employer address, user photographs, email addresses, emails, phone numbers, home address, communication history with a host user, preferred contact method, preferred contact hours, past engagement levels with meeting invitations, projected engagement levels with meeting invitations, etc., with the understanding that this listing is provided for illustrative purposes only and is not to be construed as limiting. The stored contact information can be indexed such that the contact management system 114 can be searched across any variable or any portion of the stored contact information. For example, a host user might filter the contact information stored in his contact management system 114 to return only those contacts employed at Company A with a job title of ‘Purchasing Manager’. In this manner, the host user is able to quickly and efficiently identify his saved contacts as desired, and can then proceed to generate and transmit meeting invitations to one or more of these contacts. In some embodiments, host user interface layer 110 may directly communicate with contact management system 114 to enter new or updated contact information, or to perform the aforementioned filtering process. In some embodiments, scheduler 120 may be an intermediary in one or both of these types of communication, which can be necessary, for example, in order to configured scheduler 120 to automatically filter contact information stored in contact management system 114 to find entries compatible with one or more customizable fields specified by a template selected from template repository 112.

Finally, scheduler 120 is communicatively coupled to a calendaring resource indicating the availability of the given host user. As depicted in architecture 100, this calendaring resource is provided via calendar API 116, although it is appreciated that a local calendar system can be employed without departing from the scope of the present disclosure. Calendar API 116 can provide a communicative link between scheduler 120 and an external or third party calendar platform where the given host user has different calendar events and general availability information stored. Via host user interface layer 110, the given host user can specify a calendar service (thereby specifying the API to be used in calendar API 116) to be used and can further provide a login credential or a login permission such that scheduler 120 can access, via calendar API 116, the stored availability information of the given host user. In some embodiments, one or more different calendar APIs might be provided for a single host user, and any detected discrepancies in availability from the different calendars might be flagged for host user review or might be accepted such that any time listed as unavailable in at least one calendar is listed as unavailable by scheduler 120. Calendar API 116 can be accessed by scheduler 120 in an on-demand fashion, in a periodic fashion to build and refresh a cached availability of the host user, or can be mirrored by scheduler 120 such that a local copy of the availability information specified by calendar API 116 is stored and updated in a push or pull operation. Once a meeting invitation (e.g. meeting invitation 121) is created for the host user by scheduler 120, this meeting invitation 121 can be pushed to calendar API 116 in order to reflect the change in availability information of the host user, as the selected time block for the meeting invitation will be listed as unavailable unless the meeting is canceled or modified. In some embodiments, calendar API 116 can propagate meeting invitation 121 back to the third party/external calendar service with which calendar API 116 is associated, such that the host user will see the booked meeting time and the meeting information associated with the meeting invitation 121 even when viewing his or her calendar directly on the third party calendar service.

In order for the propagation to take place, scheduler 120 should first create this meeting invitation for an online meeting session between, for example, the host user and at least one invitee. With the host user interface layer 110 and various inputs of host-related data to scheduler 120 discussed above, the disclosure turns now to invitee user interface layer 102 and its various associated inputs to scheduler 120. Invitee user interface layer 102 can be login or account controlled to be user-specific in the same or similar manner as host user interface 110. In some embodiments, for ease of use by invited users (e.g. invitees), invitee user interface layer 102 can be accessible without requiring registration or a unique account. For example, access to the invitee user interface layer 102 can be conferred by possession of a unique URL corresponding to a meeting invitation 121 generated by scheduler 120. In such an example, a host user might specify a meeting time, meeting information/parameters, and meeting invitees to thereby cause scheduler 120 to transmit a meeting invite containing a unique URL to each meeting invitee. In some examples, each host user can have a standing unique URL specific to the host user that can be used for an on-demand meeting, with anyone in possession of the host user unique URL at any time. In some embodiments, invitee user interface layer 102 may not require a unique URL for access, but can be configured in various other manners to ensure that only meeting invitees are able to access invitee user interface layer 102.

The above description assumes that a host user or other individuals communicatively coupled with scheduler 120 via host user interface layer 110 has specified the meeting time and/or meeting information and parameters. In some embodiments, it is contemplated that meeting scheduling is an interactive process, receiving information and inputs from both a host user and one or more invited users (invitees). As such, invitee user interface layer 102 is communicatively coupled to scheduler 120. Via this communicative coupling, one or more invited users might receive (e.g. transmitted by scheduler 120 or invitee user interface layer 102) or access (e.g. a link to scheduler 120 or invitee user interface layer 102 is transmitted by an external or third-party system or platform) a meeting invitation that has not yet been configured with a meeting time.

Such a meeting invitation might include the text “I would love to set up a meeting at your convenience! Click the link below to view my upcoming availability and select a time that works best for you!” or something to the same effect, indicating that a meeting has been proposed by the host user but that the invited user is free to select the best time based on their own schedule. In this sense, scheduler 120 first generates an incomplete meeting invitation, e.g., lacking a meeting time, based on parameters and inputs specified by a host user via host user interface layer 110 or previously stored in an account associated with that host user, and subsequently updates the incomplete meeting invitation to include a meeting time selected by an invited user. In instances where the incomplete meeting invite is a one-to-few or one-to-many type transmission, wherein the host transmits the invite to more than one invitee, then the same incomplete meeting invitation can be transmitted to each invitee, and a unique completed meeting invitation can be generated based on the specific time selected by any given invitee.

Scheduler 120 may also update an incomplete meeting invitation to include a supplemental meeting component selected or specified by the one or more invitees using a service aggregator API 140. Service aggregator API 140 can be an integrated component of the meeting system seen in architecture 100, or can be a third-party or external service, depending upon how architecture 100 has been configured and deployed. In general, service aggregator API 140 is provided as an adaptive and dynamic means to best configure a host user's meeting invitation in view of both the host and one or more invitees. For example, the supplemental meeting component might specify the videoconferencing platform to be used for the meeting, which can be useful if the invitee has a videoconferencing platform already integrated into his daily routine or his computing device, e.g. if the invitee works for a company that markets videoconferencing software he would prefer to use his company's service.

The supplemental meeting component can be utilized to specify various services that may be used to augment the meeting or meeting experience. For example, the supplemental meeting component might be a transcription or speech recognition service to automatically generate a transcript of the meeting and transmit it to all meeting participants, in which case service aggregator API 140 provides the ability to communicate with, select, and configure a desired transcription service. The supplemental meeting component might be used to coordinate additional meeting hardware at one or more remote locations of an invitee, e.g. the host user specifies via the supplemental meeting component one or more models of projector or high-definition display screen available to be shipped to an invitee's remote location for the upcoming meeting, and service aggregator API 140 provides APIs or communicative access to one or more rental platforms capable of providing the desired hardware to the invitee's remote location. In yet another example, the supplemental meeting component might be a hot meal delivered to each meeting participant and service aggregator API 140 is an API that aggregates and facilitates the online ordering of food from a wide geographical network of participating restaurants and food facilities. It is appreciated that these three scenarios are provided by way of example and are not presented as limiting.

In instances where the host user has enabled supplemental meeting components to be customized and added to the meeting and/or meeting invitation by one or more invitees, then invitee user interface layer 102 will prompt an invited user to access service aggregator API 140 in order to make a selection in accordance with specified supplemental meeting component parameters given by the host user. In some embodiments, rather than causing the invited user to access service aggregator API 140 directly, invitee user interface layer 102 might instead retrieve information relating to supplemental meeting components and options and repackage this information for display such that the invited user instead interacts with invitee user interface layer 102 directly.

In operation, scheduler 120 can receive one or more specified supplemental meeting component parameters from host user interface layer 110, can retrieve one or more stored supplemental meeting component parameters associated with the host user coupled to host user interface layer 110, or some combination of the two. These supplemental meeting parameters can specify restrictions or inputs that are to be provided to or placed on service aggregator API 140 and the subsequent selection of a supplemental meeting component by an invited user. For example, in the scenario discussed above wherein service aggregator API 140 offers online food ordering as a supplemental meeting component, then the supplemental meeting component parameters might specify a maximum budget to be made available to the invitee, eligible restaurants to be made available to the invitee (e.g., a meeting of a vegan health group should be shown only restaurants with vegan menu items), whether delivery is permissible, whether takeout is permissible, whether the invitee may spend their own money for any portion beyond the maximum budget, etc.

In some embodiments, these supplemental meeting parameters can be saved and indexed or otherwise correlated with individual contacts stored in the host user's contact management system 114 in order to thereby provide a more tailored meeting invitation to those invitees recognized by architecture 100. These correlations can be input via host user interface layer 110 (e.g. a certain contact is an important executive and should always be given a budget of $100), input via invitee user interface layer (e.g. if an invitee notes a food allergy in the process of interacting with service aggregator API 140, scheduler 120 will save this information into contact management system 114 for future use), or automatically determined by an analytics system 130 (e.g. calculate an invitee's average order cost, order preferences, etc.). In some embodiments, analytics system 130 (which will be discussed in greater depth below) can be operative to predict the input supplemental meeting parameters for transmission to the service aggregator API 140 that are most likely to result in a positive outcome of meeting invitation 121.

The supplemental meeting parameters, as described above, are established or transmitted via the communicative link between scheduler 120 and service aggregator API 140. With these parameters in order, invitee user interface layer 102 and service aggregator API 140 are communicatively linked in order for a selected invited user to make one or more selections pertaining to the supplemental meeting component, e.g. in the above example the invited user would select a food order to be added to the incomplete meeting invitation to thereby yield a complete meeting invitation for a meeting between the host user and the invited user.

In light of the various embodiments discussed above, meeting invitation 121 is considered ‘complete’ when it no longer has any outstanding parameters that have not yet been assigned a value. In some examples, the outstanding parameters are a subset of all possible parameters. That is, a threshold number (e.g., set by the system, host user, etc.) of the possible parameters can be required for a ‘complete’ invitation without requiring all of the possible parameters. For example, meeting invitation 121 is not complete until it receives (if needed) a meeting time selection via invitee user interface layer 102, or is not complete until it receives (if enabled) a supplemental meeting component selected by the invited user via invitee user interface layer 102 and service aggregator API 140. In some embodiments, a host may include a proposed meeting time with meeting invitation 121 and can optionally permit the invited user to change the meeting time if desired, in which case the original meeting invitation with the proposed meeting time is considered complete or tentatively complete. In some embodiments, a host may enable a supplemental meeting component selection without requiring that the invited user make a selection, in which case the first meeting invitation 121 received by the invited user is considered complete or tentatively complete.

Because meeting invitation 121 is typically transmitted in advance of the proposed or selected meeting time, and because invitees often may decline meeting invitation 121, architecture 100 is further equipped with an engagement monitor system 124 and the previously mentioned analytics system 130. Engagement monitor system 124 can sit, transparently, on the communicative path through which meeting invitation 121 is transmitted from scheduler 120 to invitee user interface layer 102. In other words, the invited user is unaware of the presence or activity of engagement monitor system 124. Engagement monitor 124 can perform functions to detect whether or not a given invitee has engaged with meeting invitation 121 and to determine the extent to which the given invitee has engaged with one or more of invitee user interface layer 102, scheduler 120, and service aggregator API 140. For example, if meeting invitation 121 is transmitted to the invitee as an e-mail or other form of online communication, engagement monitor 124 can monitor whether or not the e-mail or online communication, and therefore meeting invitation 121, has been opened or viewed by the invitee. In order to do so, engagement monitor 124 can insert an invisible tracking pixel into the invitation that will generate an indication when the invitee opens the invitation, or engagement monitor 124 can check to see if a server which hosts image/object content contained in the invitation has been accessed by the computing device of the invitee, which indicates that the invitee has opened the invitation.

Engagement monitor 124 can be further operative to silently intercept and analyze communications and actions from the invitee, using, for example, one or more cookies or session captures from invitee user interface layer 102 and/or scheduler 120. Using this data, engagement monitor 124 can determine whether or not the invitee browsed the availability data retrieved from calendar API 116 of the host user, whether or not the invitee browsed the supplemental meeting options from service aggregator API 140, for how long the invitee browsed either of the above, and whether or not the invitee made any selections of the supplemental meeting options. These detected criteria might indicate a greater level of interest on the part of the invitee as compared to an invitee who opens the invitation and takes no further action. Accordingly, this engagement analysis conducted by engagement monitor 124 can be particularly helpful in coordinating follow-up actions and communications with scheduler 120.

For example, if engagement monitor 124 determines that meeting invitation 121 has gone unopened for a week, then it can control scheduler 120 to transmit a reminder message, which contains a new copy of the meeting invitation 121. If engagement monitor 124 determines that meeting invitation 121 has been opened, but that the invitee has not viewed available times or available supplemental meeting options, then it can control scheduler 120 to transmit a reminder message requesting that the user view available meeting times and available supplemental meeting options. If engagement monitor 124 determines that the invitee has viewed available times but not made a selection, it can transmit a message asking if a currently unavailable time might be more suitable (and can additionally transmit a notification to the host user/host user interface layer 110 indicating a probable lost connection between the host user and one or more invitees due to scheduling conflict). If engagement monitor 124 determines that the invitee has viewed the available supplemental meeting options but was unable to make a selection compatible with the parameters imposed by the host user (e.g. could not create a delivery order within the specified budget, could not find delivery restaurants open at the selected meeting time, etc.), then scheduler 120 can transmit a notification to the host user or to host user interface layer 110 that identifies the one or more problematic parameters that were observed as causing the invitee to quit the supplemental meeting component selection process.

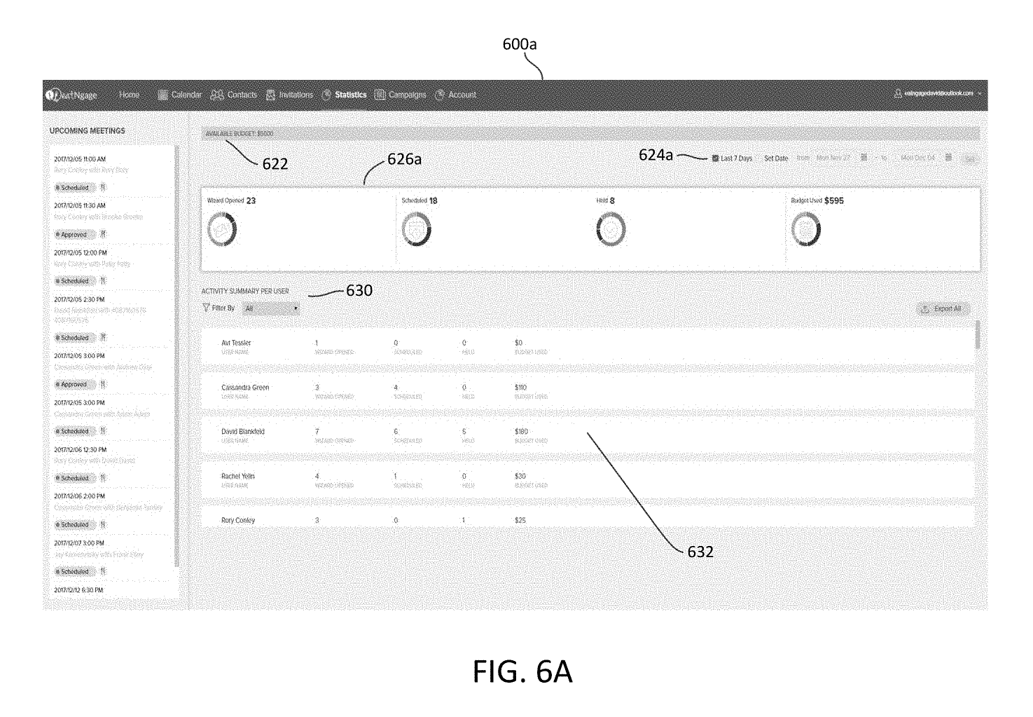

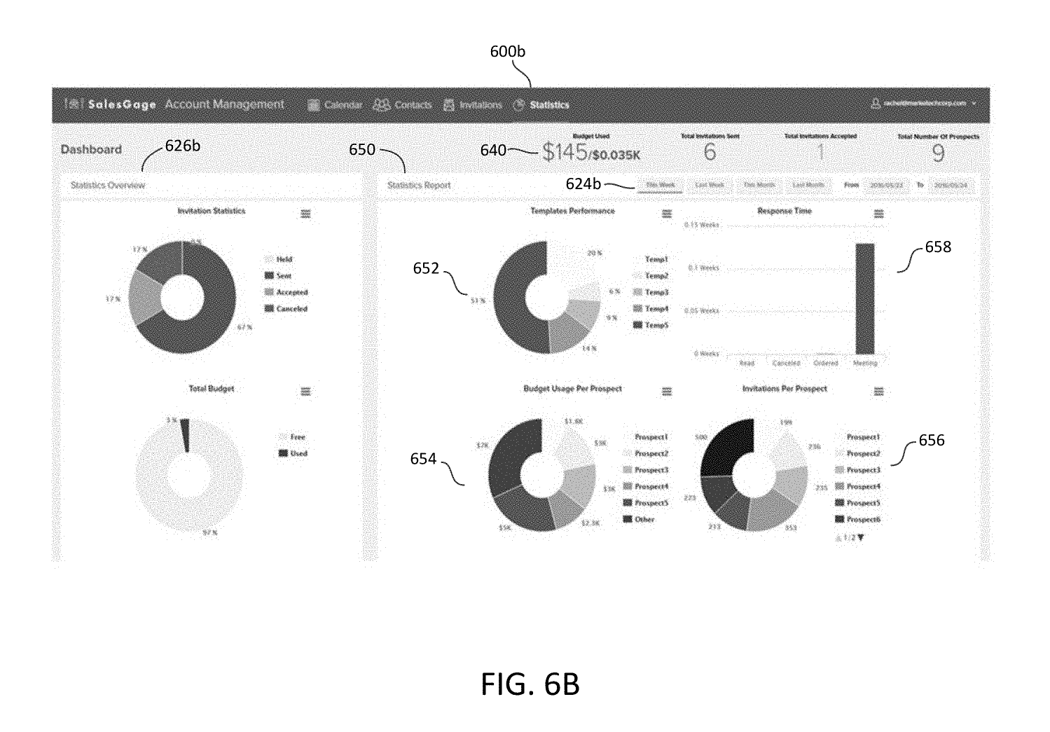

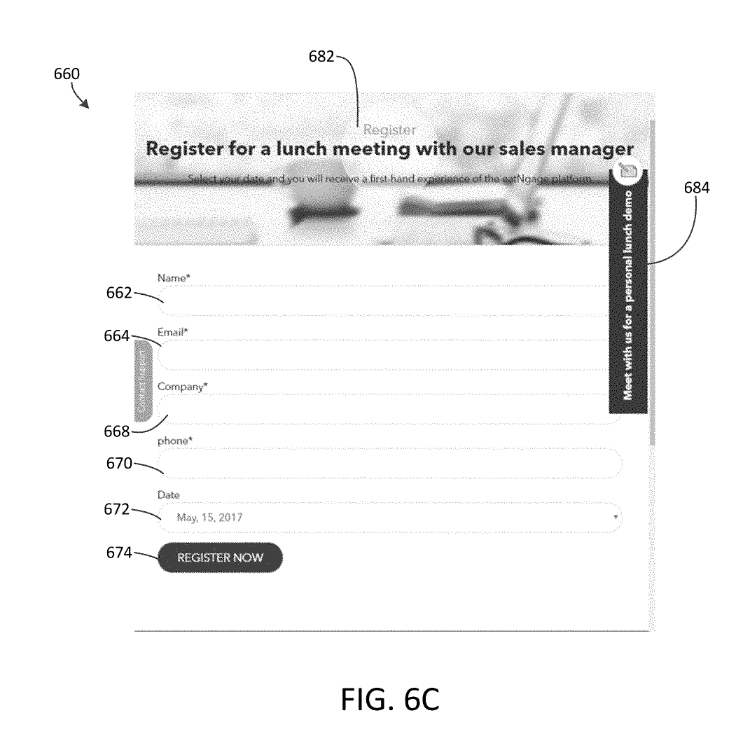

Engagement monitor 124 can continue to operate in the same or similar fashion as scheduler 120 generates and transmits any of these reminder or follow-up messages and notifications, such that invitee engagement with both meeting invitation 121 and the disclosed meeting system as a whole can be monitored and quantified. In some embodiments, this monitoring and quantification can be performed by engagement monitor 124. In some embodiments, architecture 100 can provide an analytics system 130, which is operative to analyze, either independently or in conjunction with engagement monitor 124, the performance of various meeting invitations transmitted by a given host user or a given collection of host users (e.g. a company's sales team, customer support, technical support, etc.). As illustrated, analytics system 130 receives as input meeting invitation 121 (and any subsequent updates, changes, or modifications made to the meeting invitation by either the host user or an invitee), engagement statistics from engagement monitor 124, tracking actions and inputs from invitee user interface layer 102, and meeting parameters from a meeting platform 150 which is used to provide the meeting specified by meeting invitation 121. It is appreciated that various other combinations of inputs can be received by analytics system 130 without departing from the scope of the present disclosure. Further discussion of analytics system 130 will be later made with reference to FIGS. 6A and 6B, although it is noted for the time being that it is generally contemplated that analytics system 130 is operable to provide substantially real-time feedback to one or more host users regarding ongoing performance of various meetings and meeting invitations and to provide predictive outputs to yield an optimal future performance of various meetings and meeting invitations.

As illustrated, meeting platform 150 comprises several sub-components: an attendee management and confirmation system 152, a videoconference API 154 (either integral to architecture 100 or provided by an external or third party), and a messaging API 156 (either integral to architecture 100 or provided by an external or third party), although it is appreciated that various other components for providing a meeting platform may be utilized without departing from the scope of the present disclosure.

Meeting platform 150 can receive meeting invitation 121 and use it to generate a corresponding meeting object or meeting space (not depicted) based on one or more parameters specified within the meeting invitation 121. In some embodiments, this meeting object can be generated by one or both of videoconference API 154 and messaging API 156, or the meeting object can be generated by meeting platform 150 in order to provide a framework which makes appropriate calls to one or more of videoconference API 154 and messaging API 156 as needed in order to provide the desired online meeting. Meeting platform 150 can be provided integral to architecture 100, or can be provided as an external component, system, or service. As mentioned previously, in some embodiments, a selection of a meeting platform for use in architecture 100 might be given as the supplemental meeting component selected by an invitee via service aggregator API 140. Accordingly, in order to either provide the desired meeting platform implementation, or to augment the existing meeting platform 150 of architecture 100, service aggregator API 140 is illustrated as being communicatively linked with meeting platform 150.

In general, attendee management and confirmation system 152 can act to provide at least day-of or day-prior reminders to invitees who previously accepted meeting invitation 121 (e.g. such a determination of the invitees which should be reminder by confirmation system 152 can be made in conjunction with an invitee list or invitee status list compiled by scheduler 120), much in the same manner in which scheduler 120 was previously described as being able to transmit reminders to invitees. These reminders and other communications from attendee management and confirmation system 152 can be made via communicative links between host user interface layer 110 and meeting platform 150 and communicative links between invitee user interface layer 102 and meeting platform 150—the same communicative links which may be used to connect the host user and the one or more invitees to a meeting object generated from meeting invitation 121. In some examples, the invitee user can be required to take an affirmative action, at a time prior to the meeting, to confirm attendance to the meeting and to confirm any customized meeting parameters or supplemental meeting components.

Additionally, at or near the scheduled meeting start time, attendee management and confirmation system 152 can begin a check-in process to both facilitate a connection between the invitee user interface layer 102 of each attending invitee and to provide an indication to one or more of host user interface layer 110 and analytics system 130 as to which invitees ultimately attended the meeting and which invitees did not attend the meeting, but had confirmed they would attend. This attendance information (e.g. the ‘reliability’ of an invitee who has indicated that they will attend) can be saved as analytics information and/or can be saved to the invitee's profile in contact management system 114, or some combination of the two. In some embodiments, any no-show information can further be conveyed to service aggregator API 140, such that any supplemental meeting component specified by a no-show user can be canceled, removed, or repurposed if possible.

In some embodiments, attendee management and confirmation system 152 might perform a day-of confirmation with each invitee who had previously accepted meeting invitation 121, for example, as a final confirmation step before the meeting will be held. Upon final confirmation, attendee management and confirmation system 152 can convey the final confirmation for each confirmed invitee to service aggregator API 140 to thereby confirm that any supplemental meeting component specified by the confirmed invitee should be generated and transmitted to meeting platform 150. For example, in the scenario in which the supplemental meeting component is a meal ordered by the confirmed invitee, upon receiving a final confirmation attendee management and confirmation system 152 can submit the meal order for each confirmed invitee to service aggregator API 140, which then acts to deliver or provide the ordered meals in time for the meeting scheduled on meeting platform 150. This process will later be explained in greater depth with respect to subsequent figures and examples.

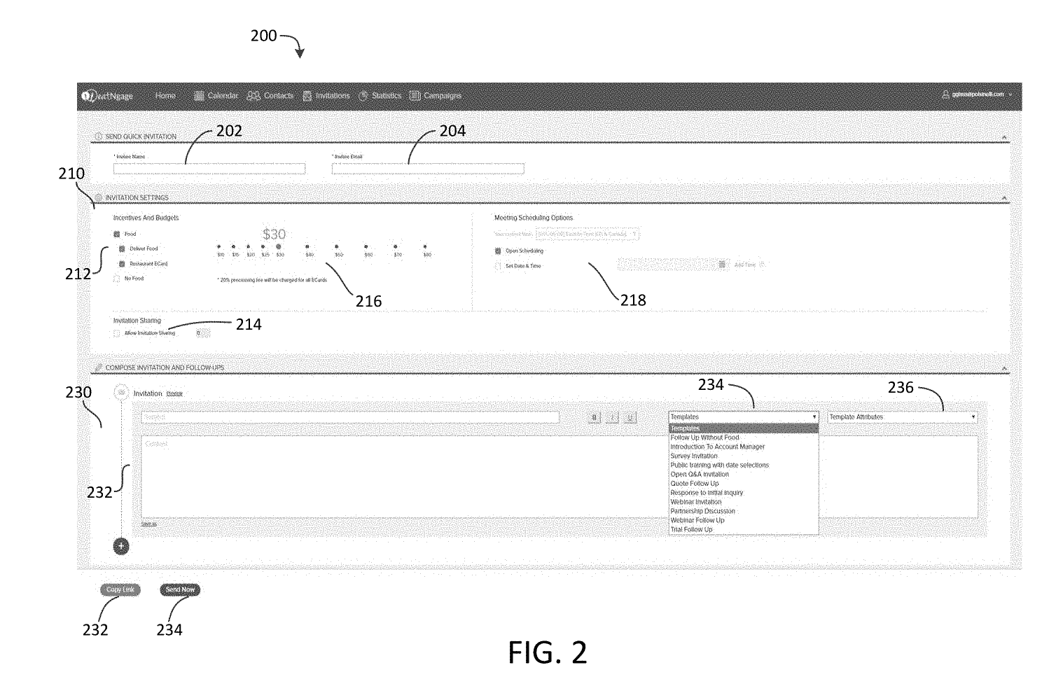

The disclosure turns now to an example implementation of the previously described meeting system and architecture 100, drawn to a scenario wherein the supplemental meeting component comprises an ordered meal, although as mentioned previously, this is not intended as limiting with respect to the range of various supplemental meeting components contemplated by the present disclosure. FIG. 2 depicts an example host user interface 200 for generating a new meeting invitation, such as meeting invitation 121 of FIG. 1. The user interface 200 can be accessed via the host user interface layer 110 of FIG. 1, for example, and the invitation process might begin with a host user selecting one or more desired invitees using an invitee name field 202 and/or an invitee contact info (e.g. email) field 204. These fields can be dynamic and configured to search the contact management repository 114 of FIG. 1 that corresponds to the host user. In instances wherein host users have shared access to each other's contact management repositories, the fields 202 and 204 can dynamically search all contacts that may be stored by the disclosed meeting system. In this manner, individual invitees may be identified and added to an invitee list for the meeting invitation being generated by user interface 200. In some embodiments, invitees may be grouped for quicker selection, and these groups may additionally be searchable along with the invitee names as described above. In other examples, the host user can add invitee contact information manually.

User interface 200 further includes an invitation settings portion 210, which allows various aspects of the meeting invitation to be customized by the host user. As mentioned previously, these customizations can be input by the host user during creation of the meeting invitation, or might be pre-loaded or pre-configured based on one or more saved settings associated with the host user. In other examples, the customization may be determined automatically for previous users by the host user and/or responses previously received from the invitee contact (e.g., historical information iteratively processed, etc.). For example, as illustrated, the meeting customizations include a customization 212 for the inclusion of an invitee selected supplemental meeting component, which in the context of the present example is food. Before or while creating the meeting invitation, the host user can determine whether or not invitees shall be permitted to add food to the meeting if the invitee accepts the meeting invitation. If the supplemental meeting component of food is enabled by the host user, done here by selecting the check box for ‘Food’, further customizations then become available.

For example, after enabling the food customization, the host user may further select a check box for ‘Deliver Food’ and/or ‘Restaurant Ecard’ to thereby further configure or limit the range of food selections that will be made available as supplemental meeting components. An additional customization 216 allows a maximum budget per invitee to be specified, which, as shown, can range from $10-$80, although of course other budget ranges are possible. In some embodiments, it is contemplated that this customization 216, and other customizations, may not be explicitly presented to invitees, whether via the meeting invitation or other means. Rather, an invitee may instead be notified if his attempted action is constrained by one or more host customizations only when necessary.

A further customization 214 can enable an invitee to share the meeting invitation with additional individuals who were not part of the original group of invitees selected by the host user via the invitee selection fields 202 and 204. For example, the invitee might be given a predetermined amount of invitations to invite colleagues, etc. The predetermined amount can be determined by the host user, historical information, etc. Such a sharing option can be useful in instances where the host user accidentally forgets to include an individual who otherwise should have been invited, or if an invitee thinks of individuals who should be invited but are not known to the host user. When an invitation is shared, the same customizations that are selected by the host user in user interface 200 can be applied—namely, the shared invitation might be generated to include the same supplemental meeting component and food options as the originally generated meeting invitations. In some embodiments, the host user may separately specify meeting customizations that are to be applied to invitees receiving a shared invitation. For example, the original meeting invitation may have a food budget of $30, while a shared invitation may have a different food budget (e.g., the same budget, different budget, a percentage of the invitee budget, etc.). In some embodiments, the host user may separately specify a shared budget pool for each invitee, wherein the shared budget pool is to be applied to any additional individuals with which a given invitee transmits a shared meeting invitation. Upon exceeding the allotted shared budget pool, the given invitee may be forbidden from transmitting further shared meeting invitations, or the host user may be notified for manual review and intervention.

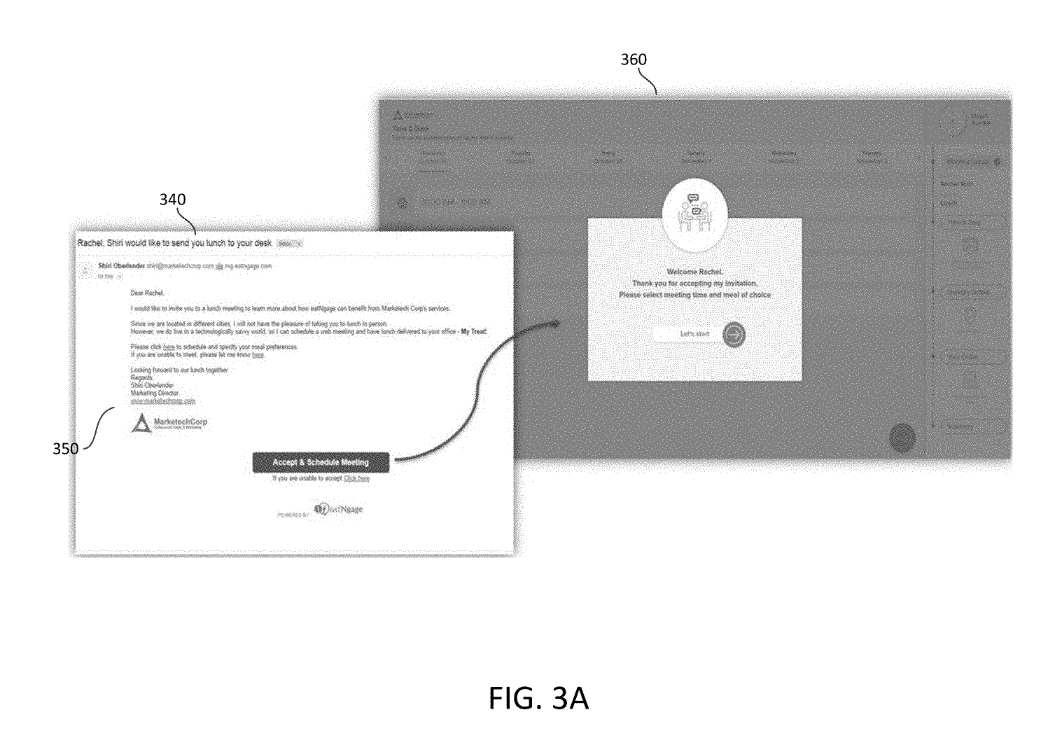

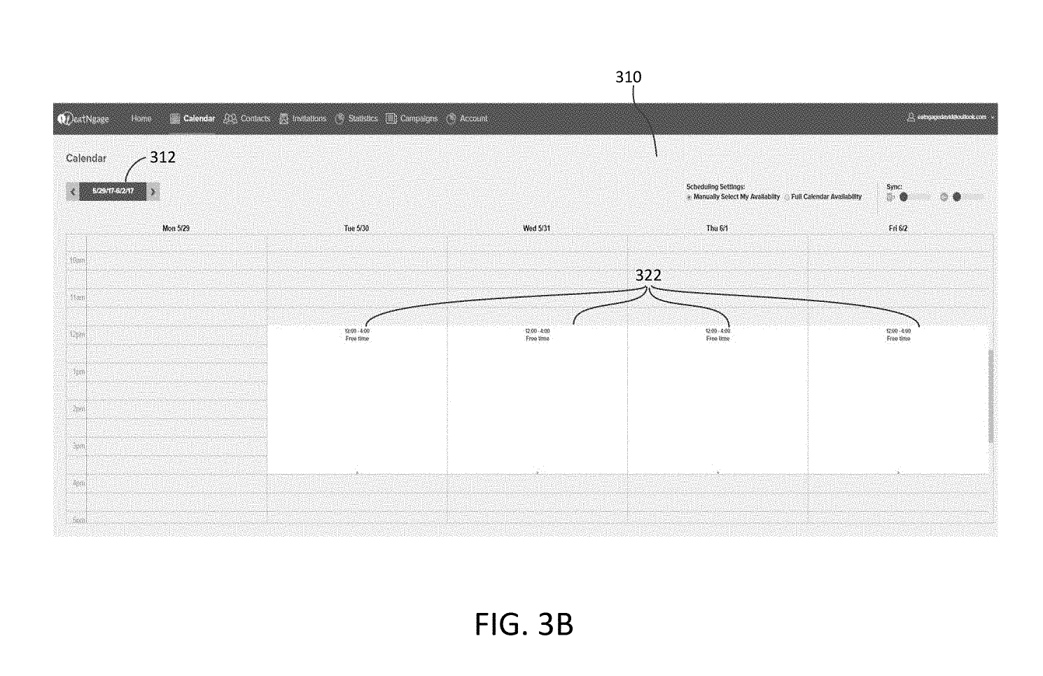

A scheduling customization 218 allows the host user to specify how the meeting time is to be selected for a given invitee. The ‘Open Scheduling’ option can permit an invitee receiving the meeting invitation to select a desired time for the meeting, for example by accessing the host user's availability via scheduler 120 and calendar API 116 of FIG. 1. As depicted in FIG. 3A, the ‘Open Scheduling’ option when selected by the host user can be translated to an invitee scheduling option 350 contained within a meeting invitation message 340 received by the invitee, for example, as an email or other electronic communication. Upon engaging the invitee scheduling option 350 (e.g. by clicking the button or link), the invitee is taken to a welcome user interface 360 that can be displayed by invitee user interface 102 of FIG. 1—prior to reaching welcome user interface 360, the invitee can be interacting with the meeting invitation message 340 on their own device and/or on some external or third party messaging platform. From welcome user interface 360, the invitee can be first directed to schedule a meeting time for the meeting described by meeting invitation message 340.

This scheduling process can be performed via a scheduling user interface 310, as seen in FIG. 3B. Scheduling user interface 310 can be presented to the invitee via invitee user interface layer 102, for example, as a refreshed user interface presented in response to the invitee selecting either the scheduling option 350 contained within the meeting invitation message 340 of FIG. 3A, or in response to the invitee selecting an interactive option in the welcome user interface 360 of FIG. 3A. The scheduling user interface 310 of FIG. 3B can display the host user's availability over a given time frame 312, which can be adjusted by the invitee. This display of the host user's availability can be populated from calendar API 116 as is needed, or might be populated from a copy of calendar API 116 mirrored to, for example, scheduler 120 and updated at a periodic basis. For the given time frame 312, the invitee is presented with one or more available time blocks 322 of the host user, which are graphically represented such that they are distinguishable from unavailable time blocks of the host user over the same time frame 312. Here, the available time blocks 322 are shown in white while all unavailable time blocks are shaded. In some embodiments, the available time blocks 322 might correspond to all empty time on the host user's calendar 116. In some embodiments, the host user might input into scheduler 120 a range of hours from which availability may be drawn. That is, the host user may block off in scheduler 120 only certain hours for scheduling meetings with invitees. For example, the host user might block off only the hours 12:00-4:00 PM on Tuesdays-Fridays for meeting with invitees, as is reflected in the availability information conveyed by available time blocks 322. Thus, from scheduling user interface 310, an invitee may make a selection of a desired time for a meeting specified by the received meeting invitation, such that the selected time is transmitted to scheduler 120 for further processing and meeting confirmation. In other examples, an invitee may request a meeting at a time not currently made available by the host user. In these situations, the host user can review and approve or deny the alternative time proposed by the invitee. The host user can also suggest a different time from the alternative time proposed.

Returning now to FIG. 2, the scheduling customization option 218 for the host user creating the meeting invite also includes, in addition to the open scheduling described above, an option for ‘Set Date & Time’. This option can forego the scheduling process performed by the invitee using the scheduling interface 310, and instead permits the host user to directly specify a meeting date and time. Such an option might be helpful when it is envisioned that the meeting will not take place in a one-on-one fashion, e.g. when the meeting is a webinar wherein the host user interacts with all the accepted invitees at once. In some embodiments, this ‘Set Date & Time’ option can be supplemented with functionality similar to that provided by scheduling user interface 310, such that the invitees can user the scheduling user interface 310 to select the various times in which they would be able to, or would be most interested in, attending the meeting. In this manner, the invitees can be polled and the meeting time can be adjusted in view of this invitee poll as needed.

User interface 200 also includes a message composition portion 230, which provides entry fields 232 for the manual entry of text or media content to comprise the body of the meeting invitation (e.g., the text to be presented to invitees upon receiving or opening the meeting invitation). In lieu of, or in addition to entry fields 232, the host user may select one or more templates 234 and template attributes 236 to utilize a pre-defined message body or message structure. For example, the body of the meeting invitation message 340 seen in FIG. 3A can be generated using the entry fields 232, via the template selection fields 234 and 236, or by some combination of the two as is desired by the host user.

The templates selected via the template selection 234 can include one or more dynamic fields that can be populated with invitee specific attributes, such as first name, employer name, current position, etc. These invitee specific attributes can be stored in and retrieved from a contact management system 114 associated with the host user, as depicted in FIG. 1. In some instances, rather than selecting a template via template selection 234, the host user can first select an invitee attribute via attribute selection 236. This selection can return a filtered list of all templates that make use of the selected attribute. For example, if the host user wishes to include a personalized greeting, he can select ‘First Name’ via attribute selection 236, to cause the template selection 234 to be filtered to only include templates with the first name attribute, at which point the host user may then select a desired template. With a template selected, the template text can appear in the entry fields 232, where it may be accepted as is or may be further edited by the host user as desired. When the host user has completed the meeting invitation process enabled by user interface 200, the host user can elect to automatically generate a link to the meeting invitation object via a ‘Copy Link’ option 242, can elect to automatically generate and transmit the meeting invitation to the specified invitees, or both. When selecting the ‘Copy Link’ option 242, the meeting invitation can be distributed via any third party or external messaging or communication service, or can provide a static option for any individual possessing the link to thereby schedule a meeting with the host user.

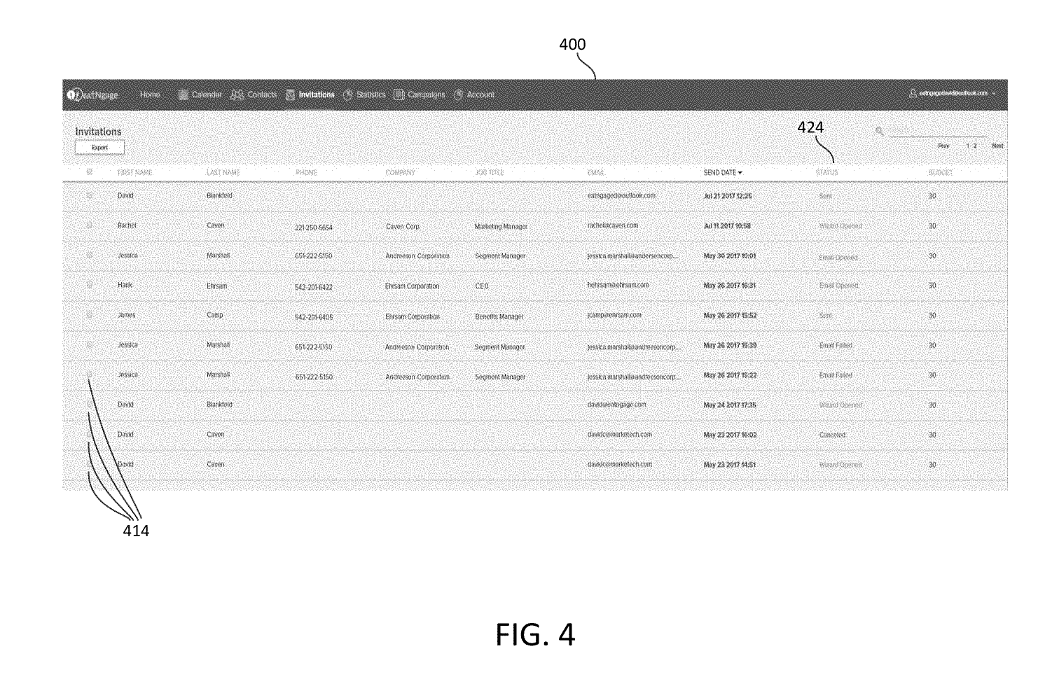

Given that meeting invitations can be distributed via multiple platforms, and that a host user can distribute multiple meeting invitations to different invitees and/or for different meetings, an invitation manager user interface 400 is provided, as seen in FIG. 4. This invitation manager user interface 400 provides an interactive, sortable, and searchable interface presenting various meeting invitations either generated by, received by, or associated with a given host user. This invitation manager user interface 400 can be provided via the host user interface layer 110 and in general presents a plurality of meeting invitations 414. The plurality of meeting invitations can be presented based on the associated invitee and meeting, as is depicted, or can be presented based on the associated meeting (e.g. a single collapsed row for each given meeting, expandable to indicate all invitee-specific invitations for the given meeting), or based on the invitee (e.g. a single collapsed row for each given invitee, expandable to indicate all meeting-specific invitations for the given invitee, etc.).

Each meeting invitation of the plurality of meeting invitations 414 is associated with an invitation status 424, which indicates a degree of invitee interaction or engagement with the given meeting invitation. Various engagement indicators can be used to signify invitation status 424, including but not limited to: ‘Sent’, indicating that the invitation has been successfully transmitted to the invitee but has not been opened; ‘Email Failed’, indicating that the invitation failed to be delivered to the invitee, e.g. due to faulty contact information; ‘Email Opened’, indicating that the invitation has been opened by the invitee but the invitee has not interacted with invitee user interface 102 of FIG. 1; ‘Wizard Opened’, indicating that the invitation has been opened by the invitee and that the invitee has interacted with invitee user interface 102 of FIG. 1; ‘Scheduled’, indicating that the invitee has interacted with invitee user interface 102 and/or scheduler 120 of FIG. 1 to schedule a meeting with the host user; ‘Canceled’, indicating that the invitation has been opened but the invitee has declined the invitation; ‘Confirmed’, indicating that the invitee has interacted with attendee management and confirmation system 152 of FIG. 1 to confirm anticipated attendance; ‘Completed’, indicating that the meeting was held and the invitee attended; and ‘No-Show’, indicating that the meeting was held but the invitee failed to attend despite confirming. The invitation status 424 information and the engagement indicators can correspond to information collected by the engagement monitor 124 of FIG. 1, which was previously described as operable to monitor invitee actions and engagement with various components of architecture 100. Although not shown, the invitation status 424 can further include a timestamped log of all past engagement indicators for a given meeting invitation, e.g. the invitation status 424 for a given meeting invitation can be expandable to indicate the time stamp at which all previous engagement indicators were achieved or marked by engagement monitor 124.

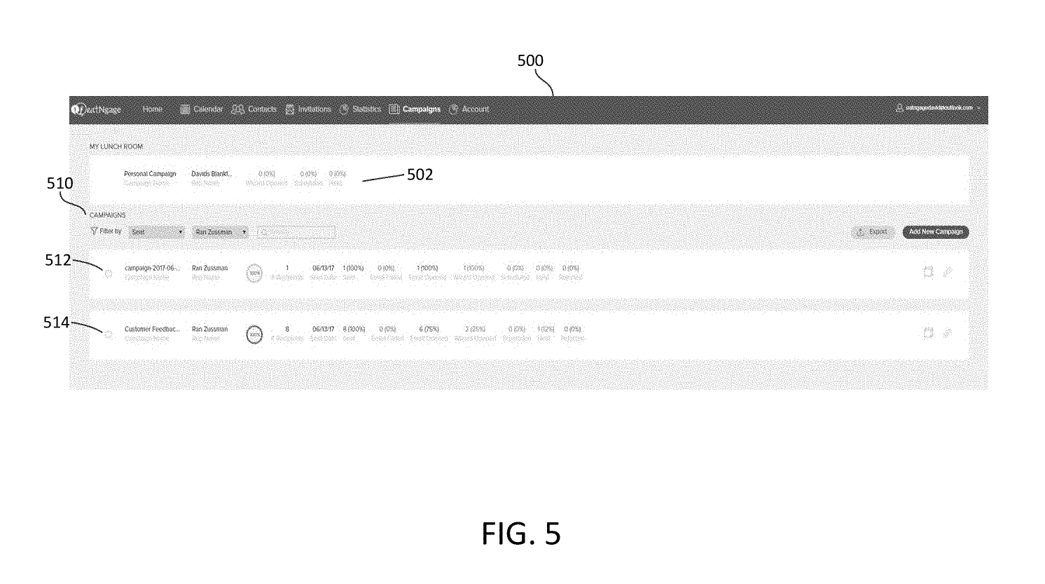

FIG. 5 depicts a campaign user interface 500, which can be provided on the host user interface layer 110 of FIG. 1. Campaigns provide a grouped or targeted structuring of various meeting invitations that are associated with one another. For example, a campaign might consist of the meeting invitations generated from June-September of the current year by one or more host users employed as salesmen for a software company, e.g., corresponding to a summer sales campaign. A campaign tab 510 displays such campaigns, with two campaigns 512 and 514 illustrated in the campaign user interface 500. A given meeting invitation might be associated with only a single campaign, or might be associated with one or more campaigns.

Campaign user interface 500 can additionally include a personal campaign 502, which might include all meeting invitations not included in one or more campaigns of campaign tab 510. In some embodiments, personal campaign 502 might include meetings that are set up by individuals in possession of a host user's static meeting room link (e.g. the static link generated by button 242 in FIG. 2). Such meetings might comprise meetings that are sought out by these individuals, rather than meetings that are initiated by the host user. For example, a host user might include his static meeting room link as a signature in all of his online communications, or include the link in all of his online profiles, such that individuals view the link and an invitation to schedule a meeting with the host user if desired. Thus, personal campaign 502 can be configured to include meeting invitations generated in this manner, at least in part to differentiate such meeting invitations from those contained within the various campaigns of campaign tab 510.

Each campaign, whether personal campaign 502 or campaigns 512 and 514, can be associated with a summary statistics display that is representative of the larger group of individual meeting invitations associated with the campaign. As depicted in FIG. 5, these summary statistics can indicate the number of different recipients (invitees) in the campaign, one or more invitation transmission dates, a number and percentage of successfully transmitted invitations, a number and percentage of unsuccessfully transmitted invitations, a number and percentage of invitations in which the invitation message has been opened, a number and percentage of invitations in which invitee user interface 102 and/or scheduler 120 have been pinged, a number and percentage of invitations in which a meeting has been scheduled, a number and percentage of invitations in which a meeting has been successfully held, a number and percentage of invitations in which the invitee has declined, etc. In some embodiments, the summary statistics of campaign user interface 500 can include all of the engagement indicators of FIG. 4, and vice versa. In some embodiments, the campaign user interface 500 and the invitation manager user interface 400 can present the same set of summary statistics/engagement indicators.

In addition to these summary statistics/engagement indicators, it is contemplated that host user interface layer 110 might further present one or more analytics user interfaces 600a and 600b, as seen in FIGS. 6A and 6B, respectively. These analytics can display results and calculations from the analytics system 130 of FIG. 1. Turning first to analytics user interface 600a, it is contemplated that such a user interface can be updated or customized to provide information pertaining to a given host user either logged in to host user interface layer 110 of FIG. 1, or otherwise specified to the analytics user interface 600a. The interface includes a budget monitor 622 (e.g., shown as indicating an available budget of $5000), which can indicate an overall available budget that has been assigned to the host user to distribute as desired across his various meeting invitations. A time selection interface 624a enables the analytics user interface 600a to be configured to calculate the displayed analytics over a specified time window, e.g. the last 7 days, or some other custom date range that can be specified by time selection interface 624a.

A meeting invitation summary pane 626a presents various graphical representations of various levels of invitee engagement with the set of meeting invitations transmitted by the host user over the time frame specified via the time selection interface 624a. For example, as depicted, meeting invitation summary pane 626a indicates that the currently analyzed set of meeting invitations generated 23 instances of ‘Wizard Opened’ (e.g., an invitee interacted with one or more of invitee user interface layer 102 or scheduler 120 of FIG. 1), generated 18 scheduled meetings, generated 8 held meetings, and used a budget of $595. This budget might represent the budget used only for completed meetings without including any budget use anticipated for the 18 scheduled meetings, might represent the budget used for both completed and scheduled meetings, or might be selectable between the two options.

A user-level analytics pane 630 allows the host user to analyze the response and engagement level of various invitees who have received one or more meeting invitations. These various invitees are each represented as one of a plurality of invitees 632 corresponding to the host user. The user-level analytics presented for each of the plurality of invitees 632 can present the same set of analytics factors that are presented in meeting invitation summary pane 626a, such that the user-level analytics pane 630 acts to provide a drill-down capability for deeper analysis of the broad results presented in summary pane 626a. These user-level analytics can provide an indication of the likelihood that a given invitee will respond to a meeting invitation (by looking at a past proportion of transmitted invitations vs. scheduled meetings), the likelihood that a given invitee will show to a scheduled meeting (by looking at a past proportion of scheduled meetings v. held meetings), the likelihood that a given invitee will open a meeting invitation (by looking at a past proportion of transmitted invitations v. wizard opened events), etc.

Analytics user interface 600b of FIG. 6B presents an alternate interface that can be used in place of, or in combination with analytics user interface 600a. Shared or similar components between the two interfaces 600a, 600b are indicated by an ‘a, b’ notation after the numerical label, e.g. the meeting invitation summary pane 626a of FIG. 6A is similar to the meeting invitation summary pane 626b of FIG. 6B.

This meeting invitation summary pane 626b provides a visualization of invitation statistics compiled into a single graph, which indicates a percentage of meeting invitations that were determined to have been ‘Held’, ‘Sent’, ‘Accepted’, or ‘Canceled’, although it is appreciated that other meeting invitation status identifiers can be employed without departing from the scope of the present disclosure. This summary pane 626b additionally includes a graphical representation of the total budget used, broken down into a ‘Free’ portion and a ‘Used’ portion. In some embodiments, it is contemplated that a host user may further interact with various portions of the graphs presented in meeting invitation summary pane 626b in order to obtain more granular details, e.g. clicking on the ‘Used’ portion of the ‘Total Budget’ graph might bring up budget use details, including a log of all expenditures per meeting, an average expenditure, and maximum, minimum, median, mean, etc. expenditures.

A tracker 640 can be provided to quickly provide an indication of a host user's meeting invitation performance, as quantified by the most important, or most immediately understandable, numbers, shown here as budget used v. total budget, total invitations sent, total invitations accepted, and total number of prospects. This tracker 640 can be used as a tool to compare, at a high-level, performance between different host users, or to compare performance in a current period against performance in prior periods for the same host user.

A time selection interface 624b allows the analytics user interface 600b to be configured to calculate the displayed analytics over only a specified time window, providing quick selection buttons providing time window options of ‘This Week’, ‘Last Week’, ‘This Month’, and ‘Last Month’, and additionally provides the ability to define a custom date range by inputting a start date and/or an end date for the desired time window for analysis and display in analytics user interface 600b.

A statistics pane 650 provides the primary analytics of analytics user interface 600b. A template performance chart 652 can provide an indication of the usage percentage of various templates, e.g. Template 5 was used in 51% of invitations while Template 2 was used in only 6% of invitations. These percentages might be drawn across all meeting invitations transmitted, or might be drawn across only different meeting events. In the first scenario, a meeting invitation transmitted to 10 invitees would count 10 times towards the denominator of the percentage calculation, while in the second scenario, this meeting invitation would count only once. Although not shown, the template performance chart 652 can provide an option to receive as input a factor over which template performance should be calculated. For example, the template performance chart 652 could be updated to break down all accepted invitations by the template used, or all held meetings by the template used, etc.

Chart 654 indicates the budget usage per prospect, providing a visual indication of those prospects which have required, from the host user's perspective, the greatest monetary investment over the time period specified via the time selection interface 624b. Although not shown, chart 654 can provide an option to receive as input a range of prospects for which to provide budget usage. For example, a host user may request to view the top 5 prospects by budget usage, or to view the sixth-tenth highest prospects by budget usage.

Response time chart 658 can provide an analysis of the average or median time elapsed for different responses to be achieved during the time period specified via time selection interface 624b. For example, the different responses, shown here on the horizontal axis, can be ‘Read’, ‘Canceled’, ‘Ordered’, and ‘Meeting’, with the vertical height of the corresponding bar for each response type indicating the average or median time elapsed before this response was achieved.

An invitation analysis chart 656 provides a breakdown of how many invitations various prospects have received, which can be helpful to avoid over-saturation of a single individual with meeting invitations to the point that the meeting invitations will no longer be opened. For example, after determining that Prospect 6 has received 500 invitations this week, it may be determined that Prospect 6 should be flagged for a cool-down period (e.g., a pre-determined period, a user-defined period, etc.) in which no more meeting invitations will be transmitted.

In some embodiments, rather than transmitting a meeting invitation or a link to set up a meeting with a host, the presently disclosed meeting system and method can instead be utilized to perform a process of automatic lead conversion. FIG. 6C depicts an example interface 660 for one such process of automatic lead conversion. In general, it is contemplated that example interface 660 might be presented as native content on a website (e.g. an automatic lead conversion interface can be placed by a company on its own website), might be presented as third-party or other advertising content (e.g. embedded in a clickable advertisement served by an advertising network), or some combination of the two.

In conventional online advertisements, individuals are prompted to first click on the ad, and subsequently, may be prompted to complete a form to answer various questions from the advertiser/advertising company about their needs and interest in the product or service being advertised. The individual is almost always prompted to provide their contact information so that a sales representative from the advertising company can follow-up, wherein the follow-up conducted by the sales representative is based off of the static contact and other miscellaneous information collected from the form. Such individuals, and their input of contact and other miscellaneous information in response to clicking an advertisement, are commonly known as ‘leads’, or potential sales opportunities for the advertising company.

Once leads are generated from various forms of online advertising, companies must then employ a large sales force of individuals who call, email, or otherwise use the provided contact information in order to communicate with leads and attempt to schedule a meeting. However, this is a time consuming and labor intensive process that leads to failure more often than not—10% is the approximate industry standard conversion rate of leads into meetings with a sales representative, as individuals willing to type their contact information into an online form are generally less willing to engage in a live conversation with a sales representative for one reason or another.

As such, it is contemplated that the presently disclosed meeting invitation link generation (e.g. the meeting link generated by button 232 of FIG. 2 or corresponding to the personal campaign 502 of FIG. 5) can be transformed or placed into an online ad to circumvent the conventional time-consuming process of lead conversion. This is one solution provided by the example interface 660 for automatic lead conversion. Rather than causing an ad to display a form for the entry of contact information, the ad can be constructed to include a button or link to automatic lead conversion interface 660 (e.g. where interface 660 is hosted by or provided by the presently disclosed meeting system) such that the interested individual is taken directly to an option to schedule a meeting with a sales representative (or ‘host user’ in the context of the previous discussion).

For example, automatic lead conversion interface 660 includes information entry fields corresponding to information needed to permit a user of interface 660 to schedule a meeting at a time of their choosing or convenience. The entry fields include a ‘Name’ field 662, an ‘Email’ field 664 (which could request other forms of online contact information besides email), a ‘Company’ field 668, a ‘Phone’ field 670, and a ‘Date’ field 672 for a requested date or a requested date and time.

In this manner, an interested individual is able to schedule an online meeting at a time and date of their choosing (that is still compatible with the host's calendar of availability), via a combination of the automatic lead conversion interface 660 and the ‘Date’ field 672. In some embodiments, upon clicking or interacting with ‘Date’ field 672, rather than being presented with an availability calendar of a single sales representative, the interested individual can be presented with a composite availability calendar of all the sales representatives associated with the advertising company (in other words, these sales representatives can comprise the set of host users underlying the particular automatic lead conversion interface, which here is interface 660), in order to thereby increase the amount of flexibility and convenience that is offered to the interested individual.

In some embodiments, a button, link, or visual indication built into the example automatic lead conversion interface 660 (or built into an online website or advertisement where automatic lead conversion interface 660 is inserted) can indicate that a potentially interested individual is welcome to customize the meeting to their liking by selecting the desired date, time, and format (in person, video call, voice call, text chat, etc.) for the meeting. For example, a guiding prompt 682 can be included in the automatic lead conversion interface 660 such that the guiding prompt 682 explains to the interested individual that they are welcome to select their date and/or time for a meeting.

Further still, automatic lead conversion interface 660 (or an online website or advertisement where automatic lead conversion interface 660 is inserted) can include a supplemental indication that the interested individual can customize the meeting according to one or more supplemental meeting components, which can further aid in the desired process of automatically converting leads into meetings. For example, in the context of the scenario wherein the supplemental meeting component is food, and as depicted herein, a visual indication 684 can be presented to potentially interested individuals, the visual indication 684 indicating that the potentially interested individual can select to conduct the meeting over lunch, either in person or virtually (e.g. over a video call or video conference). If a potentially interested individual desires to schedule a meeting, then clicking the meeting invitation generation link 674 can trigger a process highly similar to or identical to that which was previously described wherein a meeting invitation was generated by pre-populating various fields (e.g. here the meeting invitation would be pre-populated with the information provided in one or more of fields 662-672). In some embodiments, an online website or advertisement where automatic lead conversion interface 660 is inserted can contain what is referred to as a tentative acceptance button (not depicted), which can function much in the same manner as an individual clicking accept in a received meeting invitation in accordance with the foregoing description made with respect to FIGS. 1-6B.

In this manner, the presently disclosed meeting system and method automatically converts the interested individual who clicks on or otherwise interacts with an online advertisement into a scheduled sales meeting, offering numerous improvements over the conventional methods which at best can perform automated lead collection before giving way to manual phone calling and manual conversion of leads into meetings. The disclosed meeting system and method offer substantial improvements in efficiency and overall success, in both lead conversion and ultimate sales generation, as compared to the conventional method, based on factors such as the convenience offered by the online scheduling at any desired time, the engagement offered by supplemental meeting components such as food, and the temporal advantage conveyed by scheduling a meeting in immediate response to an individual's expression of interest in the product or service being advertised/sold.

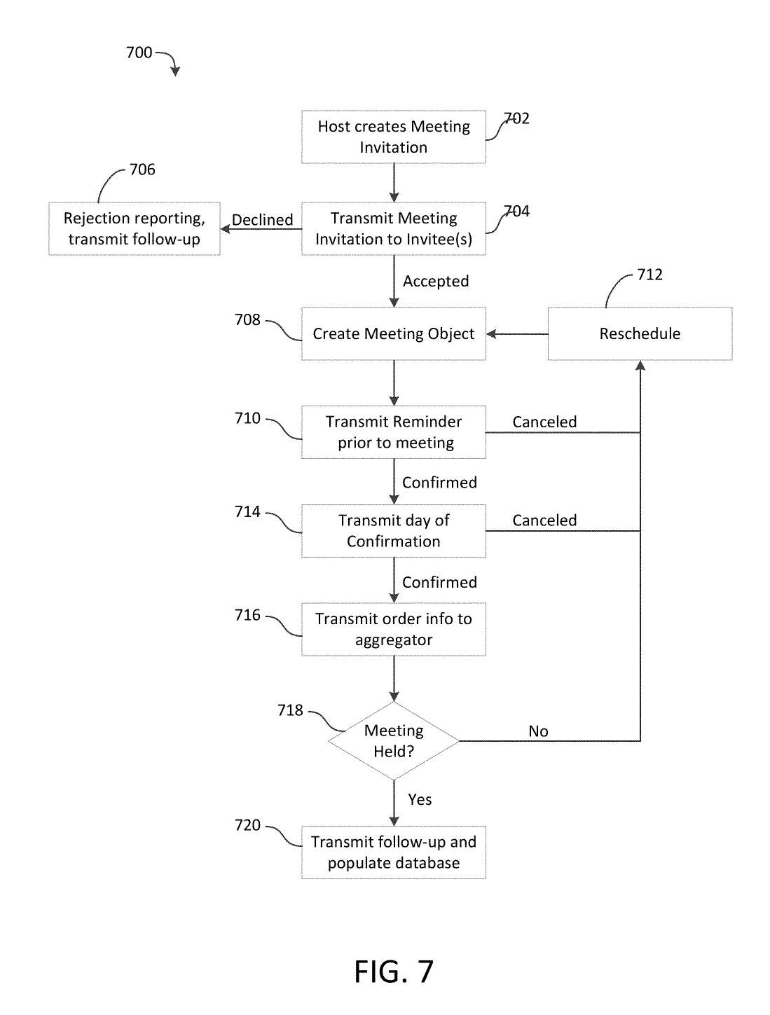

FIG. 7 depicts an exemplary flowchart 700 of a method of the present disclosure. The method shown in FIG. 7 is provided by way of example, as there are a variety of ways to carry out the method. Additionally, while the example method is illustrated with a particular order of blocks, those of ordinary skill in the art will appreciate that FIG. 7 and the blocks shown therein can be executed in any order that accomplishes the technical advantages of the present disclosure and accordingly, the method can include a greater or lesser number of blocks than illustrated.

Each block shown in FIG. 7 represents one or more processes, methods or subroutines, carried out in the example method. The blocks shown in FIG. 7 can be implemented in a system architecture 100 as shown in FIG. 1.

Method 700 can begin at block 702. At block 702, a host or host user creates a meeting invitation. The meeting invitation can be customized in one or more ways to include a desired message or body, which can be written by the host during the meeting invitation creation or can be loaded from a template. If loaded from a template, the template can be automatically populated with invitee-specific information, where available, and can be manually edited by the host as desired. The meeting invitation can include a meeting date and time, or a suggested meeting date and time, and can also include an option for the invitee to view the host's availability and schedule a time of their own choosing.

At block 704, meeting invites are transmitted to the one or more invitees selected by the host during the meeting invitation creation. The meeting invites can be transmitted to the meeting invitees via email or various other forms of online communication. In some instances, the meeting invitation can comprise the host's written message and a link or button for the invitee to click in order to view more information and/or scheduling options for the meeting. In some embodiments, the meeting invitation (e.g., link or button) might be configured such that the meeting invitation can be displayed, presented, or managed in a third party communication platform or customer relationship management (CRM) platform. In some embodiments, an API can be provided in order to communicatively couple or otherwise integrate the meeting invitation generation, scheduling, and management system disclosed above with such third party communication or CRM platforms. Once the meeting invitation is received by a given invitee, the method either proceeds to a block 706 if the meeting invitation is declined, or a block 708 if the meeting invitation is accepted

At block 706, reached if the meeting invitation is declined by a given invitee, a rejection report is generated and transmitted to the disclosed meeting system such that a profile for the given invitee can be updated to record the rejection, and various parameters surrounding the rejection, including the content of the meeting invitation itself, the elapsed time between the meeting invitation being opened and being rejected, whether or not any scheduling options for the meeting were explored before the rejection, etc. In this manner, customer preferences can be analyzed and learned such that any future meeting invitations can be better tailored to reduce the likelihood of being rejected.

At block 708, taken if the meeting invitation is accepted, the system creates a meeting object, which represents the meeting to be provided between the host user and at least the accepting invitee. In instances where the meeting will be between the host user and multiple invitees, then the meeting object can be created for the first invitee to respond and any subsequent accepting invitees can be added to the already existing meeting object. In some embodiments, the meeting might include a supplemental meeting component specified or selected by the invitee. In one example, the supplemental meeting component is food. Accordingly, this block can further include presenting one or more options or selectable parameters to the invitee for purposes of selecting the supplemental meeting component. If the invitee ultimately attends the meeting, then the selected supplemental meeting component will be made available or added to the meeting/meeting object. However, due to the risk of cancellation of the future meeting, the supplemental meeting component is not generally added to the meeting at this time, but is instead stored until some suitable time at which the supplemental meeting component must be added in order to be present by the scheduled meeting time.

At some later time, but prior to the meeting time, a reminder is transmitted to each accepted invitee at block 710. For example, the reminder might be transmitted 24 or 48 hours before the scheduled meeting time. This reminder message can be configured in the same manner as the original meeting invitation was at block 702, e.g. either input by the host himself, created based on a template, or entirely automatically generated. Similarly, the reminder message can be transmitted on any of the variety of transmission channels contemplated for use in transmitting the original meeting invitation. In some embodiments, the reminder message can be transmitted using the same transmission channel used at block 704, or can be transmitted using the same transmission channel over which the acceptance message from the invitee was received by the presently disclosed system. In response to the reminder, a confirmation is received, in which case the method proceeds to block 714, a cancelation is received, in which case the method proceeds to block 712, or no response is received, in which case the method also proceeds to block 712.

Block 712 provides a rescheduling process in response to either an explicit cancelation received from a previously accepted invitee or a lack of response over a pre-defined time period from a previously accepted invitee. In some embodiments, the rescheduling step might cause the method to return to block 702 at which point the host will create a new meeting invitation in an attempt to reschedule the canceled meeting. In some embodiments, the rescheduling step might itself generate a rescheduling message, either automatically or with some input from the host user, and then cause the method to return to block 704 and transmit the rescheduling meeting invitation. Rather than show these two optional steps, the method 700 instead depicts rescheduling block 712 returning to block 708 for creating a meeting object, which is the block that is reached no matter whether the rescheduling process returns first to block 702 or block 704.

If a confirmation is received in response to the reminder of block 710, then the method proceeds to block 712, which waits until the day of the meeting (e.g. 24 hours before the scheduled meeting time, 4 hours before the meeting time, 2 hours before the meeting time, 1 hour before the meeting time, etc.) to transmit one or more day of confirmation requests to those invitees having previously accepted the meeting and confirmed the reminder of block 710. This day of confirmation request can be generated, transmitted, and handled in much the same fashion as the reminder described in block 710. Similarly, in response to the confirmation request, if a cancelation or no response is received, then the method returns to the rescheduling block 712. If a final confirmation is received, then the method proceeds to a block 716, wherein the supplemental meeting component information is transmitted to an aggregator (e.g. service aggregator API 140 of FIG. 1) for execution, such that the supplemental meeting component is configured or otherwise properly prepared for addition to the upcoming meeting. In the example where the supplemental meeting component is food, the supplemental meeting component information is an invitee's food order, and block 716 would involve transmitting the invitee's saved food order to a food delivery aggregator or an API of the food delivery aggregator for processing and execution such that the food arrives at a desired time, typically corresponding to or substantially near the scheduled meeting time.

At block 718, the method checks to see whether or not the meeting was held. If the meeting was not held, for example because the invitee was a no-show despite confirming their attendance in both blocks 710 and 714, then the method returns to rescheduling block 712. In some embodiments, if an invitee is determined to have previously been a no-show to a confirmed meeting, then that invitee may be flagged as a high no-show risk, or may not receive future meeting invitations altogether.

If the meeting is held, then at block 720 a follow-up message and/or feedback request is transmitted to the invitee. This follow-up can be automated or based on a template, e.g. thanking the invitee for their time and asking if they have any further questions or concerns. The follow-up can include a link to provide feedback on both the meeting and the meeting scheduling experience, which can be utilized to improve the presently disclosed meeting system. In some embodiments, the follow-up can be tailored or manually composed by the host in view of the content and discussion of the earlier meeting that was held.

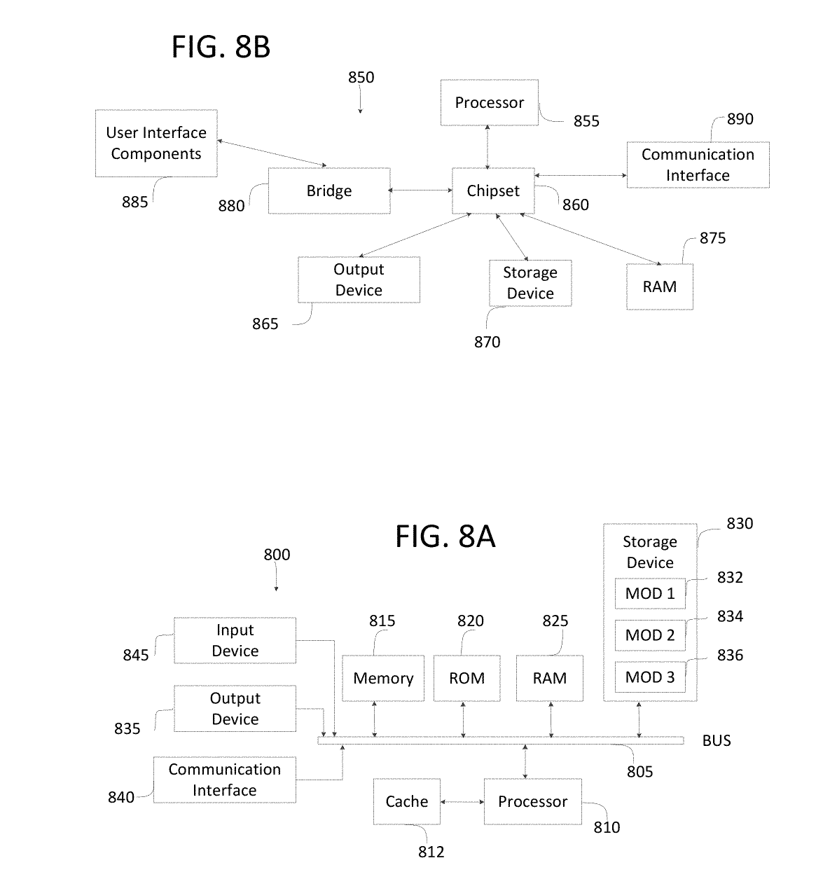

FIG. 8A and FIG. 8B illustrate example system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates an example computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output device 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that example systems 800 and 850 can have more than one processor 810 or be part of a group or cluster of computing devices networked together to provide greater processing capability.

Methods according to the aforementioned description can be implemented using computer-executable instructions that are stored or otherwise available from computer readable media. Such instructions can comprise instructions and data which cause or otherwise configure a general purpose computer, special purpose computer, or special purpose processing device to perform a certain function or group of functions. Portions of computer resources used can be accessible over a network. The computer executable instructions may be binaries, intermediate format instructions such as assembly language, firmware, or source code. Computer-readable media that may be used to store instructions, information used, and/or information created during methods according to the aforementioned description include magnetic or optical disks, flash memory, USB devices provided with non-volatile memory, networked storage devices, and so on.

For clarity of explanation, in some instances the present technology may be presented as including individual functional blocks including functional blocks comprising devices, device components, steps or routines in a method embodied in software, or combinations of hardware and software.

The computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing methods according to these disclosures can comprise hardware, firmware and/or software, and can take any of a variety of form factors. Such form factors can include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device.

The instructions, media for conveying such instructions, computing resources for executing them, and other structures for supporting such computing resources are means for providing the functions described in these disclosures.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims. Moreover, claim language reciting “at least one of” a set indicates that one member of the set or multiple members of the set satisfy the claim.

We claim:

1. A non-transitory computer-readable storage medium having instructions stored therein which, when executed by one or more processors cause the one or more processors to:
create a meeting invitation object based on one or more host customization parameters received from a host;
transmit the meeting invitation object to one or more invitees;
receive, from an invitee user interface presented in response to a given invitee interacting with the meeting invitation object, one or more invitee customization parameters and one or more supplemental meeting options;
create a scheduled meeting object based on at least the meeting invitation object and the one or more invitee customization parameters, the scheduled meeting object corresponding to a scheduled meeting time;
transmit a confirmation request to the given invitee, the confirmation request transmitted prior to the scheduled meeting time; and
in response to receiving a confirmation from the given invitee, combine the one or more supplemental meeting options with the scheduled meeting object to generate a customized online meeting session between the host and the given invitee.

2. The non-transitory computer-readable storage medium of claim 1, wherein to combine the one or more supplemental meeting options with the scheduled meeting object the instructions further cause the one or more processors to:
receive a supplemental meeting object generated based on the one or more supplemental meeting options; and
add the supplemental meeting object to the scheduled meeting object to generate the customized online meeting session between the host and the given invitee.

3. The non-transitory computer-readable storage medium of claim 1, wherein the invitee customization parameters include one or more proposed meeting times selected from calendar availability information of the host, the calendar availability information presented by the invitee user interface.

4. The non-transitory computer-readable storage medium of claim 1, wherein the invitee customization parameters include a desired meeting platform selection, and wherein the desired meeting platform is used to host the customized online meeting session between the host and the given invitee.

5. The non-transitory computer-readable storage medium of claim 1, wherein the instructions further cause the one or more processors to:
detect one or more invitee interactions with the transmitted meeting invitation object, the invitee interactions including opening the meeting invitation object and opening the invitee user interface;
for each invitee, transmit a meeting invitation reminder in response to determining that a reminder period has elapsed since a last invitee interaction was detected for the invitee; and
for each invitee, re-transmit the meeting invitation in response to determining that no invitee interaction has been detected for the invitee and that a re-transmit period has elapsed.

6. The non-transitory computer-readable storage medium of claim 5, wherein the reminder period and the re-transmit period are specified by the host customization parameters.

7. The non-transitory computer-readable storage medium of claim 1, wherein the one or more supplemental meeting options are selected from available supplemental meeting options presented by the invitee user interface, the available supplemental meeting options generated based at least in part on the one or more host customization parameters.

8. The non-transitory computer-readable storage medium of claim 7, wherein the one or more supplemental meeting options include food and wherein the host customization parameters include a maximum budget and a delivery option.

9. The non-transitory computer-readable storage medium of claim 8, wherein invitee customization parameters include an option to select an additional invitee to receive the meeting invitation object and the food supplemental meeting option.

10. The non-transitory computer-readable storage medium of claim 9, wherein the meeting invitation object is embeddable and contains a pointer to pre-populate the invitee user interface based on the one or more host customization parameters.

11. A system comprising:
one or more processors; and
at least one computer-readable storage medium having instructions stored therein which, when executed by the one or more processors, cause the system to:
create a meeting invitation object based on one or more host customization parameters received from a host;
transmit the meeting invitation object to one or more invitees;
receive, from an invitee user interface presented in response to a given invitee interacting with the meeting invitation object, one or more invitee customization parameters and one or more supplemental meeting options;
create a scheduled meeting object based on at least the meeting invitation object and the one or more invitee customization parameters, the scheduled meeting object corresponding to a scheduled meeting time;
transmit a confirmation request to the given invitee, the confirmation request transmitted prior to the scheduled meeting time; and
in response to receiving a confirmation from the given invitee, combine the one or more supplemental meeting options with the scheduled meeting object to generate a customized online meeting session between the host and the given invitee.

12. The system of claim 11, wherein to combine the one or more supplemental meeting options with the scheduled meeting object the instructions further cause the system to:
receive a supplemental meeting object generated based on the one or more supplemental meeting options; and
add the supplemental meeting object to the scheduled meeting object to generate the customized online meeting session between the host and the given invitee.

13. The system of claim 11, wherein the invitee customization parameters include one or more proposed meeting times selected from calendar availability information of the host, the calendar availability information presented by the invitee user interface.

14. The system of claim 11, wherein the invitee customization parameters include a desired meeting platform selection, and wherein the desired meeting platform is used to host the customized online meeting session between the host and the given invitee.

15. The system of claim 11, wherein the instructions further cause the system to:
detect one or more invitee interactions with the transmitted meeting invitation object, the invitee interactions including opening the meeting invitation object and opening the invitee user interface;
for each invitee, transmit a meeting invitation reminder in response to determining that a reminder period has elapsed since a last invitee interaction was detected for the invitee; and
for each invitee, re-transmit the meeting invitation in response to determining that no invitee interaction has been detected for the invitee and that a re-transmit period has elapsed.

16. The system of claim 15, wherein the reminder period and the re-transmit period are specified by the host customization parameters.

17. The system of claim 11, wherein the one or more supplemental meeting options are selected from available supplemental meeting options presented by the invitee user interface, the available supplemental meeting options generated based at least in part on the one or more host customization parameters.

18. The system of claim 17, wherein the one or more supplemental meeting options include food and wherein the host customization parameters include a maximum budget and a delivery option.

19. The system of claim 18, wherein invitee customization parameters include an option to select an additional invitee to receive the meeting invitation object and the food supplemental meeting option.

20. The system of claim 19, wherein the meeting invitation object is embeddable and contains a pointer to pre-populate the invitee user interface based on the one or more host customization parameters.
